(19) United States
(12) Patent Application Publication
(10) Pub. No.: US 2010/0112985 A1
(43) Pub. Date: May 6, 2010

(54) METHOD AND SYSTEM FOR IDENTIFIER MAPPING TO SERVICE CAPABILITY

(75) Inventors: Edoardo Gavita, Laval (CA); Zhongwen Zhu, Saint-Laurent (CA); Nazin Hossain, Brossard (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/265,455

(22) Filed: Nov. 5, 2008

(51) Int. Cl. H04M 3/42

(52) U.S. Cl. 455/414.1

(57) ABSTRACT

A method and communication server for mapping an address to a service capability, wherein a server determines if a service requested in a service request, such as for example in a SIP (Session Initiation Protocol) INVITE message, can be initiated with a first user identifier. The server further determines an alternate user identifier when determined that the service cannot be initiated with the first user identifier replaces the first user identifier with the alternate user identifier in the request for the service, so that the requested service can be successfully established.

### TECHNICAL FIELD

The present invention relates to the area of address mapping.

### BACKGROUND

At the present time a user's contact list has limited types of addresses that can be stored therein. For example, the contact list can store phone numbers and e-mail addresses, but can't store SIP URI's (Session Initiation Protocol Uniform Resource Identifier).

Furthermore, in a scenario where one of the contacts in the users' contact list has multiple phone numbers that have different service capabilities associated with them (for example, one identifier number can only be used to make either a voice call, SMS (Short Message Service) or MMS (Multimedia Messaging Service), whereas another identifier number can only be used for IMS Services (IP Multimedia Subsystem) there is presently no way to qualify the identifier number with service capability in the contact list.

A partial solution to the aforementioned problem can be to configure the terminating user's network to provide a mechanism for routing incoming requests via appropriate means based on user B's terminal capabilities, or User B's preferences. However, the problem persists in a multi-operator environment; for example, in the scenario where a user tries to reach (via his IMS network) another User (ex. user B) served by a different operator.

FIG. 1 (Prior Art) shows this exemplary multi-operator environment. In this scenario UE-A (160), served by Operator 1 (102) is trying to reach via an IMS network (140) UE-B (170), served by Operator 2 (104). UE-B (170) has multiple communication addresses, and if UE-A (160) does not or is not capable of selecting the correct communication address from his client, UE-A (160) originating operator network (120) would not be able to route the IMS requests to the appropriate terminating foreign operator's network. If the wrong identifier number of UE-B (170) is used in the SIP request, the originating side's DNS (ENUM) (Domain Number System E-number) (150) look up would fail. If the two users were served by the same operator, the ENUM could be configured to associate UE-B's (170) identifier number to the appropriate IMS capable address.

However, since UE-B (170) is served by a different operator (104), DNS configuration would not be enough, especially in the scenario where the operator (104) is not the same operator (106) that is providing UE-B (170) with the IMS Services.

While there is no prior art alike the invention described herein, the publication FR 2 899 753 bears some relation with the field of the present invention. In this publication.

Monnet et al describes how to modify the structure of an address. The method involves receiving an electronic mail by an electronic mail transfer, system of a simple mail transfer protocol (SMTP) type messaging server. An electronic mail's header processing module is used to modify user addresses in the header, by a transformation unit, by adding a domain name indicating an application server and displacing at-sign from one position towards another position in front of the added name to increase the length of a user name in a modified address. An at-sign replacement character is added to the former position of the at-sign by the unit.

Therefore, the ways suggested by the prior art for establishing new communications with users having multiple identities can create problems such as dropped communications or sub-optimal use of available services

The present invention addresses these shortcomings

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is an exemplary high-level network diagram illustrating a multi-operator environment where UE-A, served by one operator, is trying to reach UE-B, served by another operator, according to a known prior art scheme;

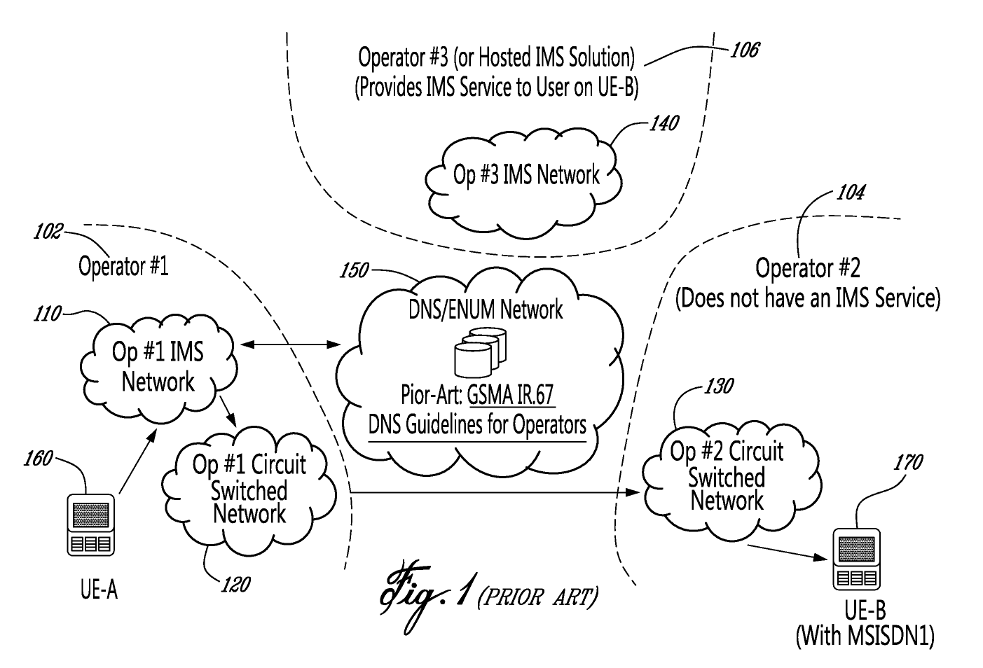

FIG. 2a is an exemplary high-level network and signal flow diagram of an IP Multimedia Subsystem (IMS) network containing a variant of the preferred embodiment of the present invention;

FIG. 2b is an exemplary diagram of a database containing a further variant of the preferred embodiment of the present invention;

FIG. 3 is an exemplary nodal operation and signal flow diagram of a multi-operator environment where UE-A, served by one operator, communicates with UE-B, served by another operator according to a variant of the preferred embodiment of the present invention;

FIG. 4 is an exemplary flowchart diagram of a method for mapping a service request from one user identifier to a second user identifier according to a preferred embodiment of the present invention; and

FIG. 5 is an exemplary flowchart diagram a method for mapping a service request from one user identifier to a second user identifier according to a further embodiment of the present invention.

### DETAILED DESCRIPTION

The innovative teachings of the present invention will described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

According to the present invention and its related preferred embodiments, there is provided a method and a telecommunications server for mapping a service request from one user identifier to another user identifier.

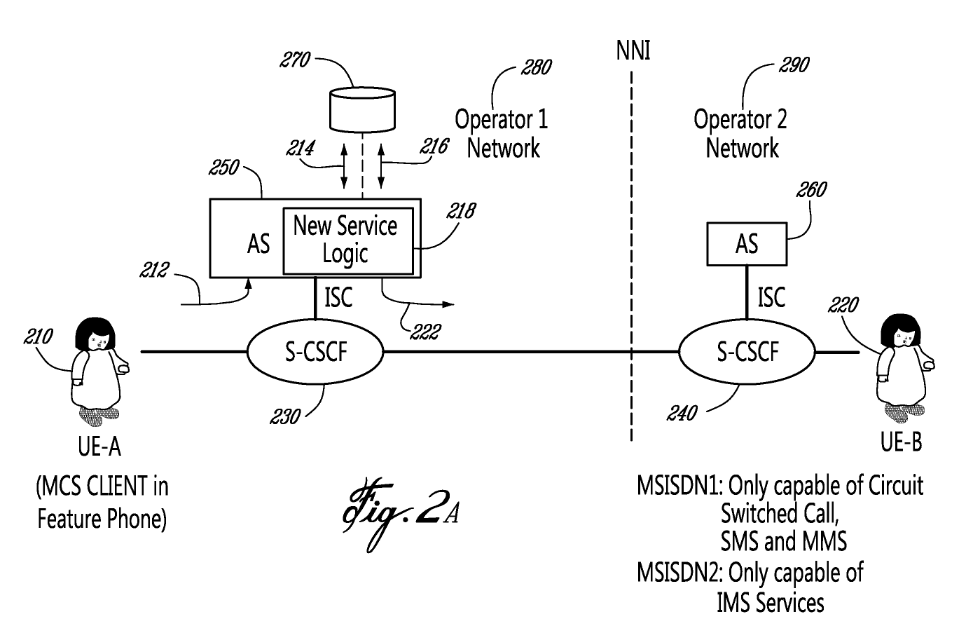

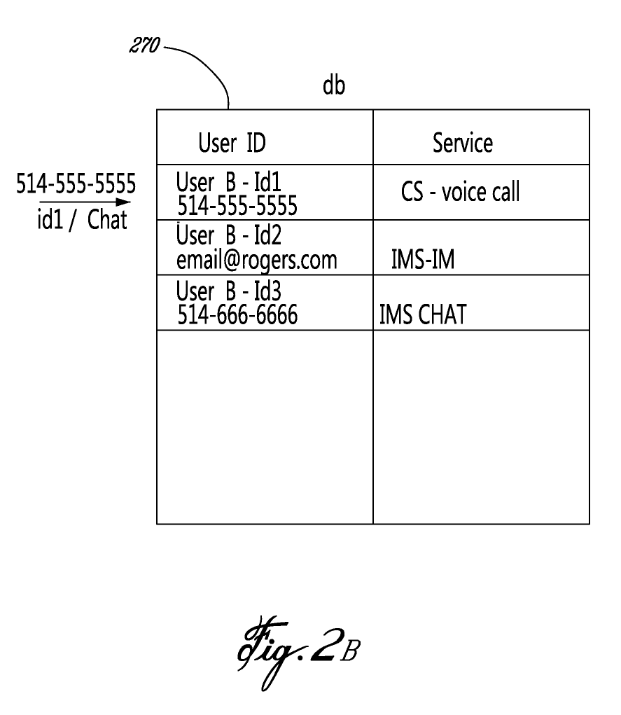

Reference is now made to FIG. 2a which shows an exemplary high-level network and signal flow diagram of an IP Multimedia Subsystem (IMS) network containing a variant of the preferred embodiment of the present invention.

Shown in FIG. 2a is a multi-operator network wherein a first user wishes to communicate with a second user without being aware of the service capabilities of the second user. It is to be understood that this is only an exemplary scenario, and that the invention can be advantageously implemented in various types of networks.

Shown in FIG. 2a is a user UE-A (210) served by an Operator 1's IMS Network (280) sending a SIP (Session Initiated Protocol) request) with “Request URI (Uniform Resource Identifier) header set to MSISDN1 (MS International ISDN Number1)” to the Application Server (250) in order to request the launching of the service in connection with the user identified by the MSISDN1. The new service logic (218) verifies (step 214) with a database (270) if the address in the Request URI can be used for SIP requests, i.e. if for example the requested service can be started using the MSISDN1.

If the address in the Request URI is not IMS capable, i.e. for example if the requested service cannot be started using the MSISDN1, then the database sends back a message (step 216) to the new service logic (218) that an IMS capable address of UE-B (220) is needed. In the New Service Logic (218) the “Request URI” header value of the SIP request is modified so that it contains another address, for example an IMS capable address of UE-B (220), MSISDN2. The SIP request is then forwarded from the originating Serving Call Session Control Function (S-CSCF) (230) to the terminating S-CSCF (240) in Operator 2 (290). The modified request URI allows the SIP request to reach UE-B's (220) IMS Network, on the terminating side.

Reference is made to FIG. 2b which shows a diagram of a exemplary database containing a further variant of the preferred embodiment of the present invention.

Shown in FIG. 2b is the same database (270) found in FIG. 2a but showing in more detail the mapping of a User ID to a service capability. The database (270) stores the Identifier mapping to Service Capability for a plurality of users. In the present example, UE-B (220) has three different identifiers (also called herein addresses) mapped to three different service capabilities. UE-B (Identifier 1) is mapped to a circuit switch voice call. UE-B (Identifier 2) is mapped to IMS-IM, while UE-B (Identifier 3) is mapped to IMS Chat. Such an association shows the particular identifiers of UE-B that should be used when requesting establishment of the associated service with UE-B. For example, if a user would like to do IMS chat with UE-B, the service request should use UE-B's Identifier 3.

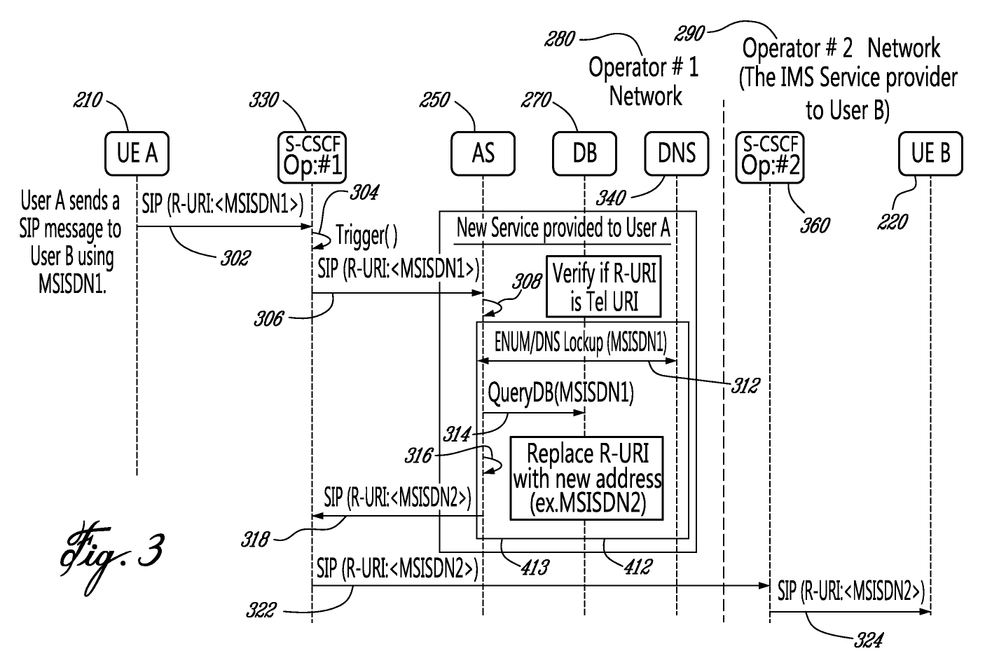

Reference is made to FIG. 3, which shows an exemplary nodal operation and signal flow diagram of a multi-operator environment where UE-A (210) served by operator 1's IMS Network (280), communicates with UE-B (220) served by another operator (290). It is to be understood that this is only an exemplary scenario, and that the invention can be advantageously implemented in various types of networks, such as for example email networks, non-IMS Instant messaging networks, etc.

Shown in FIG. 3 is UE-A (210) that wishes to send, from Operator 1's IMS Network (280) a SIP message to UE-B (220) using MSISDN1. Operator 1's IMS Network (280) further comprises a Serving Call Session Control Function (S-CSCF) (330) which performs the session control services for the endpoint. This includes routing of originating sessions to external networks and routing of terminating sessions to visited networks. The operator 1's IMS Network (280) further comprises an Application Server (AS) (250) that provides verification of identifier information, MSISDN1 lookup, querying for MSISDN1 and identifier replacement. The Operator 1 further comprises a database (270) for the storage of the identifier mapping to Service capability. The DNS (Domain Name System) (340) is a network of databases that translates Internet Domain Systems into IP addresses.

The exemplary scenario in FIG. 3 may start with User A UE-A (210) sending a SIP message to User B UE-B (220) using MSISDN1 (MS International ISDN Number). The SIP message is sent to the S-CSCF (330) where there is a trigger (304) for sending SIP messages to the AS (250) with the identifier mapping service. Within the AS (250) the verification of the Uniform Resource Identifier (308) is carried out to see if it is a Telephone Uniform Resource Identifier. The DNS (340) is checked to see if the MSISDN1 can be mapped to a SIP URI, such as for example if the user ID be mapped to a particular user capability as shown in FIG. 2b. If the MSISDN1 cannot be mapped to a SIP URI, then the database (270) is queried for an IMS service capable address using MSISDN1. If the query finds the MSISDN1 in the database (270), then the new service will replace MSISDN1 with new MSISDN2 or SIP URI. Thereafter the identifier is propagated to UE-B (220) in Operator 2 (290) via the S-CSCF (360).

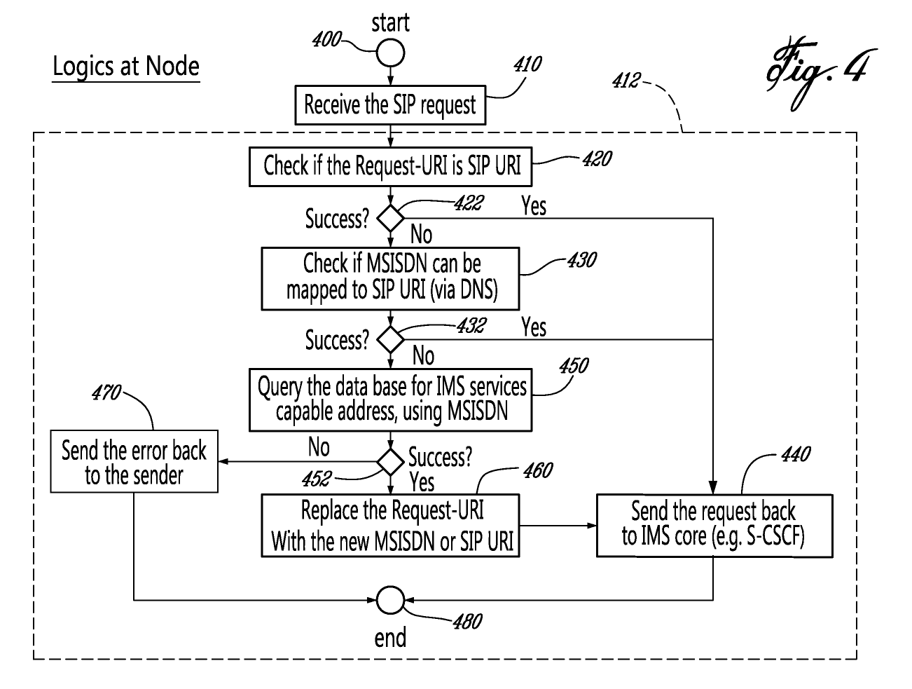

Reference is now made to FIG. 4 that shows an exemplary flowchart diagram of a method for mapping a service request from one user identifier to a second user identifier according to a preferred embodiment of the present invention.

The flowchart in FIG. 4 is described as being implemented in an application server (AS), although it is to be understood that this is only an example, and that the invention can be advantageously implemented in various types of networks and nodes.

The process starts at step 400 which is followed by the receipt of the SIP request at step 410. The request is then checked if the URI contained in the SIP request is a SIP URI (step 420). If at step 422 it is determined that the URI is a SIP URI then the request is sent back to IMS core (step 440) and from there to the destination (e.g. to User B). If at step 422 it is otherwise determined that the URI is not a SIP URI, then it is checked if it is possible to map the MSISDN to the SIP URI (via e.g. the DNS), step 430. If the determination is yes (step 432), then the request is sent back to the IMS Core (step 440), and from there to the destination (e.g. to User B). If the determination is negative (step 432), the database is queried for IMS services capable address, using MSISDN (step 450). If the user has an IMS service capable address then the requested URI is replaced with the new MSISDN or the SIP URI (Step 460). Thereafter, the request is sent back to the IMS Core (Step 440). The flow ends at step 480. If at step 452 the determination is that the user does not have an IMS capable address, then an error message is sent back to the sender (step 470). The flow ends at step 480.

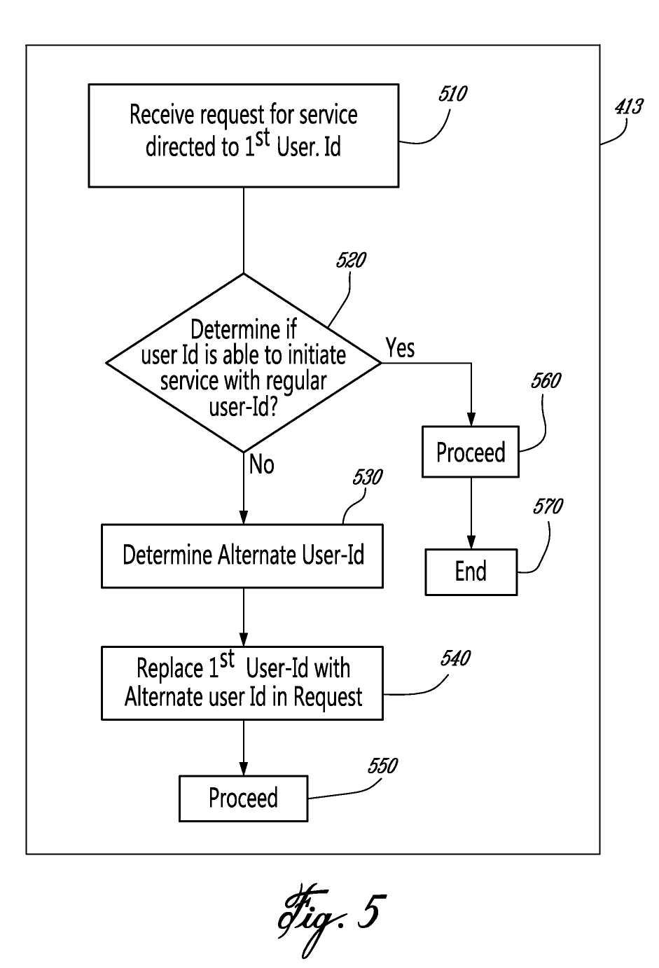

Reference is now made to FIG. 5, which shows an exemplary flowchart diagram of a method for mapping a service request from one user identifier to a second user identifier according to a further embodiment of the present invention.

The flowchart in FIG. 5 is described as being implemented in an application server (AS), although it is to be understood that this is only an example, and that the invention can be advantageously implemented in various types of networks and nodes. A receive request for service is directed to a 1^{st} user identifier (step 510). It is then determined if the user identifier can be used to initiate the service (step 520). For example, it is determined if the first ID is associated with an IMS-SIP service, or if the first ID is appropriate for such a service, or otherwise, if there is not another more appropriate ID of that user that could be used for that service. If it is then determined that the user identifier can be used to initiate the service, then the flow proceeds as normal (step 560) and the service is initiated. Once this is completed, the flow ends (step 570). If it is rather determined that the user identifier is not cannot be used to initiate the service, then an alternate user identifier is determined (step 530) that is able to initiate the service. The first user identifier is then replaced with the alternate user identifier in the request (step 550). The flow then proceeds as normal (step 550), with the alternate user identifier in the request, and the service is initiated using the alternate user identifier.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for mapping an address to a service capability, the method comprising the steps of:
a. receiving a request for a service directed to a first user identifier;
b. determining if the service can be initiated with the first user identifier;
c. determining an alternate user identifier when determined that the service cannot be initiated with the first user identifier; and
d. replacing the first user identifier with the alternate user identifier in the request for the service.

2. The method according to claim 1, wherein the service capability is a Voice Call.

3. The method according to claim 1, wherein the Service Capability is an IP Multimedia Subsystem Message (IMS-M).

4. The method according to claim 1, wherein the service capability is an IMS Chat.

5. The method according to claim 1, wherein steps a through d take place in an application server of a communication network.

6. The method according to claim 5, wherein the communication network is an IMS (IP Multimedia Subsystem) network.

7. The method according to claim 6, where the first user identifier is a telephone number.

8. The method according to claim 7, where the first user identifier is in a second IMS network.

9. The method according to claim 1, where the user identifier is a telephone number.

10. The method according to claim 1, where the alternate user identifier is an e-mail address.

11. The method according to claim 1, further comprising the step (between b and c) of:
checking if the MSISDN can be mapped to the SIP URI (via DNS); and
if the responsive is negative querying the database for IMS Services capable address, using MSISDN.

12. A communication server comprising:
a database for storing an user identifier mapping to service capability;
a service logic module, that responsive to receiving a service request directed to a first user identifier, determines if a user identifier is able to initiate the service with a regular user identifier, determines an alternate user identifier from the database when determined that the service cannot be initiated with the first user identifier and replaces the first user identifier with an alternate user identifier in the request.

13. The database claimed in claim 11 wherein the user identifier is a telephone number.

14. The database claimed in claim 11 where the user identifier is an e-mail address.

15. The database claimed in claim 11 where the service capability is a voice call.

16. The database claimed in claim 11 where the service capability is an IMS-M (IP Multimedia Subsystem Message).

17. The database claimed in claim 11 where the service capability is an IMS Chat.
